(19) United States
(12) Patent Application Publication
(10) Pub. No.: US 2014/0358776 A1
(43) Pub. Date: Dec. 4, 2014

(54) RULE-BASED FUNDS ALLOCATION IN ELECTRONIC TRANSACTIONS

(71) Applicants: Wei Xu, Millwood, NY (US); Elizabeth Platko, Cortlandt Manor, NY (US)

(72) Inventors: Wei Xu, Millwood, NY (US); Elizabeth Platko, Cortlandt Manor, NY (US)

(73) Assignee: MasterCard International Incorporated, Purchase, NY (US)

(21) Appl. No.: 13/908,406

(22) Filed: Jun. 3, 2013

(51) Int. Cl. G06Q 20/10; G06Q 20/36; G06Q 20/22

(52) U.S. Cl. CPC G06Q 20/10; G06Q 20/227; G06Q 20/36
USPC 705/41

(57) ABSTRACT

A computer processor is used to determine, based on funds data that specifies at least an amount of received funds and a payor associated with a transaction, whether any allocation rule among a plurality of allocation rules is applicable for allocation of the received funds. If an allocation rule is applicable for allocation of the received funds, then the allocation rule is evaluated with the funds data to identify at least one account category, wherein each account category is associated with at least one account of a payee associated with the transaction. At least a portion of the received funds is allocated to at least one of the accounts associated with the identified account category or categories.

### FIELD

Aspects of the present disclosure relate in general to financial services regarding electronic funds transactions, and more particularly to rule-based allocation of incoming funds.

### BACKGROUND

Electronic wallets (sometimes referred to as digital wallets) have become popular for conducting a variety of financial transactions electronically. A user accesses her electronic wallet through a program or application, e.g., during the checkout phase in an electronic commerce (e-commerce) application. Electronic wallets typically have data associated with various cards (e.g., physical credit or debit cards) and/or accounts, e.g., real or virtual accounts or sub-accounts. With the proliferation of electronic commerce and electronic funds transactions, the typical number of cards and/or accounts associated with an electronic wallet has increased, resulting in increasing complexity of some tasks for the user of the electronic wallet.

### SUMMARY

In an embodiment corresponding to a computer-implemented method of allocating funds, funds data is received. The funds data specifies at least an amount of received funds and a payor associated with a transaction. A computer processor is used to determine, based on the funds data, whether any allocation rule among a plurality of allocation rules is applicable for allocation of the received funds. If an allocation rule is applicable for allocation of the received funds, then the allocation rule is evaluated with the funds data to identify at least one account category, wherein each account category is associated with at least one account of a payee associated with the transaction. At least a portion of the received funds is allocated to at least one of the accounts associated with the identified account category or categories.

In another embodiment, a non-transitory computer readable storage medium has instructions stored thereon. When executed, the instructions cause a computer processor to perform the operations of the computer-implemented method of allocating funds described above.

In another embodiment corresponding to a computer-implemented method of allocating funds, funds data is received. The funds data specifies at least an amount of received funds and a payor associated with a transaction. A payee associated with the transaction is an educational institution. At least one computer processor is used to determine that the payor is a parent or guardian of a student affiliated with the educational institution. If the payor is the parent or guardian of the student, then the computer processor(s) is/are used to determine whether any allocation rule among a plurality of allocation rules is applicable for allocation of the received funds. If an allocation rule is applicable for allocation of the received funds, the allocation rule is evaluated with the funds data to identify at least one account category, wherein each account category is associated with at least one account of the payee. At least a portion of the received funds is allocated to at least one of the accounts associated with the identified account category or categories.

### BRIEF DESCRIPTION OF THE DRAWINGS

The following will be apparent from elements of the figures, which are provided for illustrative purposes and are not necessarily to scale.

FIGS. 1A and 1B are block diagrams of system embodiments configured to enable rule-based allocation of funds.

FIG. 2 is a block diagram of a computer architecture in accordance with certain embodiments of the present disclosure.

FIG. 3 is a diagram illustrating an example collection of accounts, sub-accounts, and cards in accordance with certain embodiments.

FIG. 4 is a flow diagram illustrating a process for rule-based funds allocation in accordance with certain embodiments.

FIG. 5 is a flow diagram illustrating another process for rule-based funds allocation in accordance with certain embodiments.

FIG. 6 is a flow diagram illustrating another process for rule-based funds allocation in accordance with certain embodiments.

### DETAILED DESCRIPTION

This description of the exemplary embodiments is intended to be read in connection with the accompanying drawings, which are to be considered part of the entire written description.

Various embodiments of the present disclosure reduce or eliminate the burden on a user of an electronic wallet regarding the processing of incoming (receivable) funds. Using a set of rules that can be automatically evaluated, a computer system can identify one or more candidate accounts to which incoming (received) funds may be allocated. In some embodiments, the funds are allocated automatically (e.g., without needing confirmation from the user), and in other embodiments the user can be presented with options based on automatic evaluation of allocation rules. Funds can also be automatically allocated to two or more accounts according to predetermined rules (e.g., rules that specify that various accounts are to receive respective proportions of the incoming funds). Automatic allocation of incoming funds and user-controlled allocation of funds based on automatic rule evaluation, discussed in greater detail below, simplify the user's experience for maintaining or administering her electronic financial accounts.

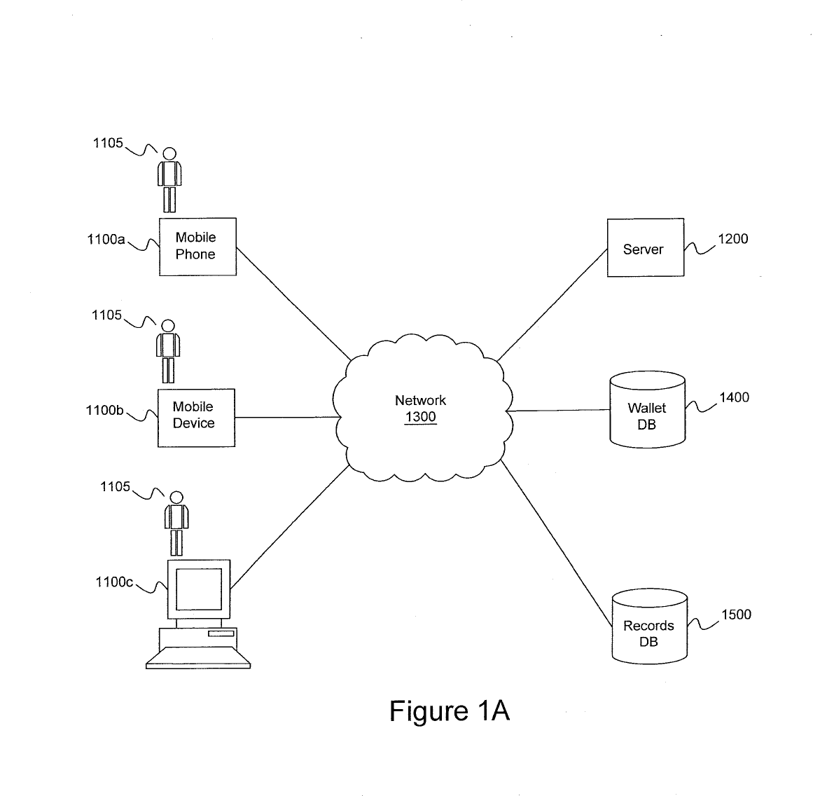

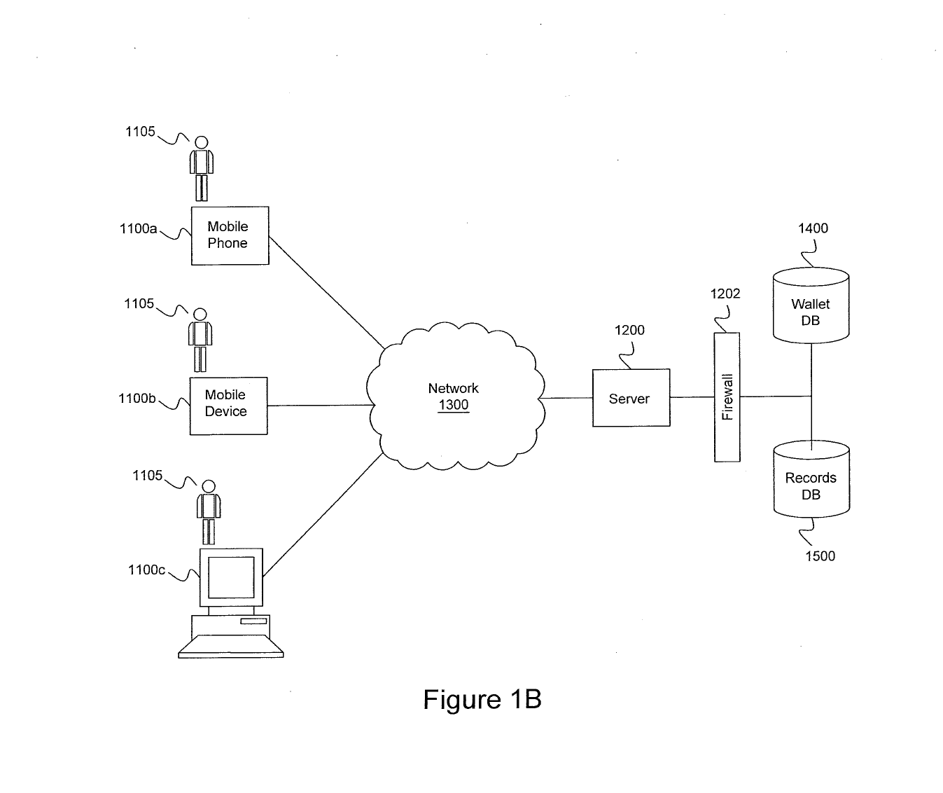

FIG. 1A is a block diagram of a system embodiment configured to enable rule-based allocation of funds. A user 1105 may access functionality related to the transfer of electronic funds by using a mobile phone 1100a, mobile device 1100b (e.g., tablet-type device), personal computer (e.g., desktop or notebook computer) 1100c, a television, or any other network-accessible computing device (any of the foregoing devices may be referred to generally as “user device 1100”) to access network 1300, which may be the Internet or may be connected to the Internet. A server 1200 is a network-side (relative to the user, which can be considered a client) computer that may be associated with a transaction solution provider (e.g., a company that enables or supports the user to perform commerce transactions electronically). Server 1200 is capable of communication with user device 1100 via network 1300.

In some embodiments, the user 1105 accesses financial transaction functionality in her own individual capacity, e.g., regarding her personal credit cards or accounts. In other embodiments, the user 1105 accesses financial transaction functionality on behalf of an organization or company with which she is associated or affiliated. For example, user 1105 may be the principal or other employee of a school that has various credit cards or accounts, or she may be an administrator or operator of a computerized financial system of a company.

In some embodiments, the user 1105 accesses financial transaction functionality using a web interface, e.g., by using a web browser at user device 1100 to access a website. For example, the user device may use a web protocol (e.g., HTTP or HTTPS) to contact a web server (which may be server 1200 or a different computer connected to network 1300) which serves web page(s) that the browser at the user device 1100 can render on a display. In other embodiments, the user accesses financial transaction functionality by using an application (e.g., an application running on a smartphone) that communicates with server 1200 through a communication protocol other than a web protocol.

Various databases may be connected to server 1200 to store information related to electronic transactions. For example, as shown in FIG. 1A, a wallet database 1400 and a records database 1500 may be connected to server 1200 via network 1300. Various network configurations can be used. In some embodiments, the wallet database 1400 and records database are directly connected to the server 1200 or are configured as shown in FIG. 1B, with a firewall 1202 protecting these databases. In the example of FIG. 1B, the server 1200, which may be referred to as a processing server, has permission to pass (cross) the firewall 1202 to retrieve from the wallet database 1400 and from the records database 1500. The wallet database 1400 may store information regarding various electronic wallets, e.g., identification information (e.g., name, address, phone number, e-mail address), account information (e.g., financial details such as routing and account numbers), and/or information regarding the current status of the wallet (e.g., amount of funds, security permissions). For example, wallet database 1400 may store data related to multiple external wallets. The records database 1500 can store various records related to transactions, e.g., for maintaining a transaction history for users.

The network topology diagrams in FIGS. 1A-1B are simplified views, and additional components may be present. For example, a firewall (not shown) may be used within network 1300 for security purposes, and an intranet may be used to connect such a firewall to the server 1200.

In various embodiments, user device 1100 is configured to receive instructions, allocation rules, and software updates from server 1200 via network 1300. Processing related to allocation of funds can occur server-side or client-side, as described further below.

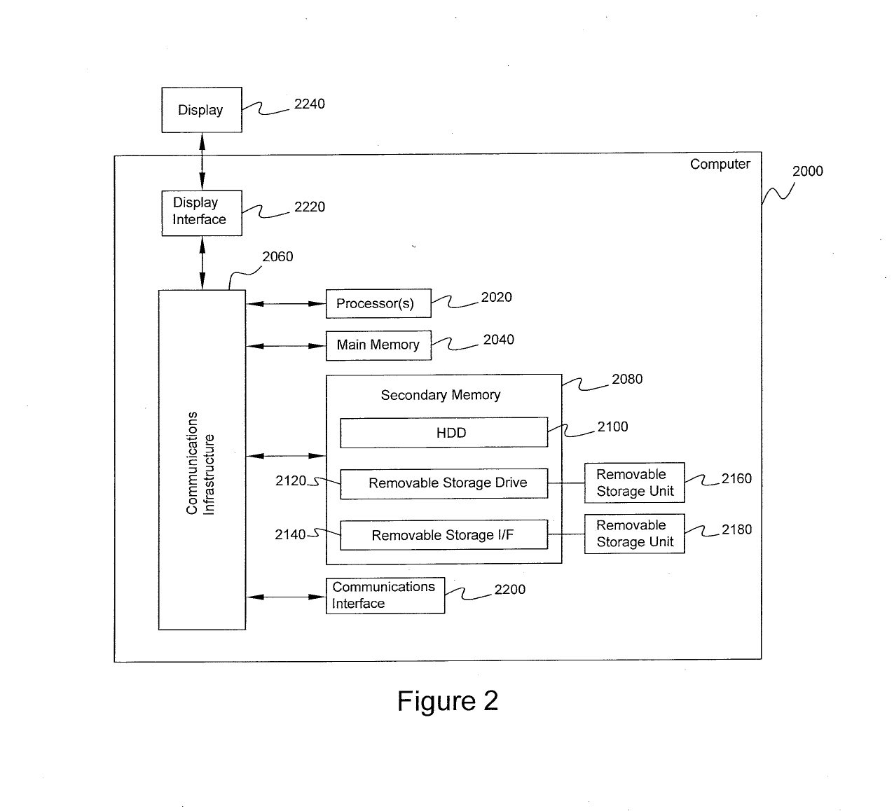

FIG. 2 is a block diagram of a computer architecture in accordance with certain embodiments of the present disclosure. Computer system 2000 may be an example implementation of server 1200 and/or user device 1100. As illustrated in FIG. 2, computer system 2000 may include one or more processors 2020. Each processor 2020 is connected to a communication infrastructure 2060 (e.g., a communications bus, cross-over bar, or network). Computer system 2000 may include a display interface 2220 that forwards graphics, text, and other data from the communication infrastructure 2060 (or from a frame buffer, not shown) for display on the display unit 2240.

Computer system 2000 may also include a main memory 2040, such as a random access memory (RAM), and a secondary memory 2080. The secondary memory 2080 may include, for example, a hard disk drive (HDD) 2100 and/or removable storage drive 2120, which may represent a floppy disk drive, a magnetic tape drive, an optical disk drive, a memory stick, or the like as is known in the art. The removable storage drive 2120 reads from and/or writes to a removable storage unit 2160. Removable storage unit 2160 may be a floppy disk, magnetic tape, optical disk, or the like. As will be understood, the removable storage unit 2160 may include a computer readable storage medium having tangibly stored therein (embodied thereon) data and/or computer software instructions, e.g., for causing the processor(s) to perform various operations.

In alternative embodiments, secondary memory 2080 may include other similar devices for allowing computer programs or other instructions to be loaded into computer system 2000. Secondary memory 2080 may include a removable storage unit 2180 (which may be similar to removable storage unit 2160) and a corresponding interface 2140, which may be similar to removable storage drive 2120. Examples of such removable storage units include, but are not limited to, USB or flash drives, which allow software and data to be transferred from the removable storage unit 2180 to computer system 2000.

Computer system 2000 may also include a communications interface 2200. Communications interface 2200 allows software and data to be transferred between computer system 2000 and external devices. Examples of communications interface 2200 may include a modem, Ethernet card, wireless network card, a Personal Computer Memory Card International Association (PCMCIA) slot and card, or the like. Software and data transferred via communications interface 2200 may be in the form of signals, which may be electronic, electromagnetic, optical, or the like that are capable of being received by communications interface 2200. These signals may be provided to communications interface 2200 via a communications path (e.g., channel), which may be implemented using wire, cable, fiber optics, a telephone line, a cellular link, a radio frequency (RF) link and other communication channels.

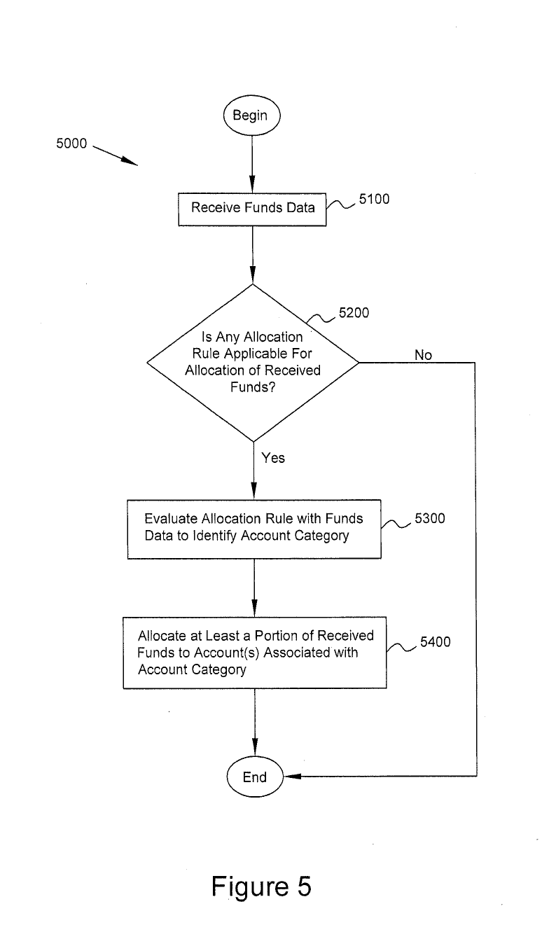

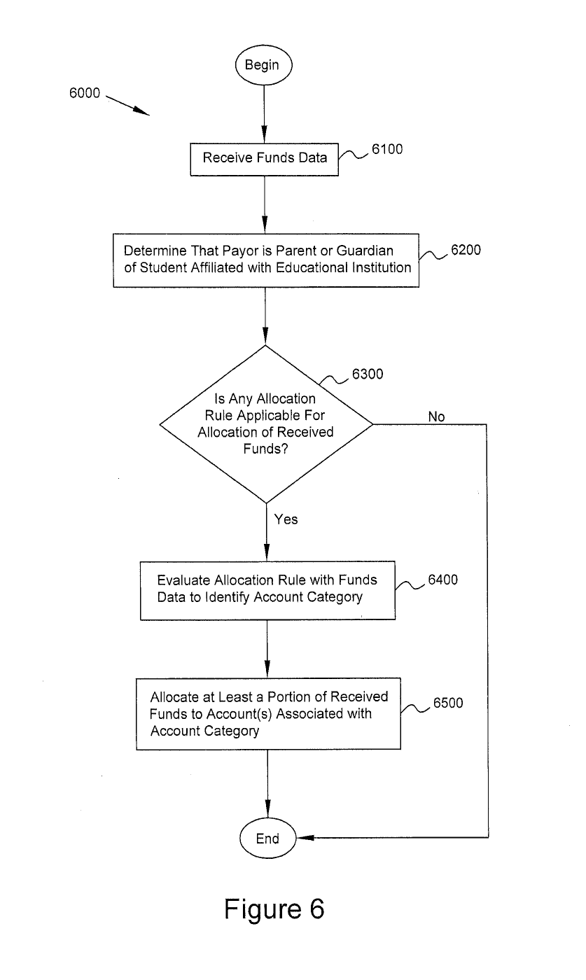

In this document, the terms “computer program medium” and “non-transitory computer readable storage medium” refer to media such as, but not limited to, media at removable storage drive 2120, or a hard disk installed in hard disk drive 2100, or removable storage unit 2160. These computer program products provide software to computer system 2000. Computer programs (also referred to as computer control logic) may be stored in main memory 2040 and/or secondary memory 2080. Computer programs may also be received via communications interface 2200. Such computer programs, when executed by a processor, enable the computer system 2000 to perform the features of the methods discussed herein. For example, main memory 2040, secondary memory 2080, or removable storage units 2160 or 2180 may be encoded with computer program code (instructions) for performing operations corresponding to various processes disclosed herein, e.g., processes 5000 or 6000 discussed below in the context of FIGS. 5 and 6.

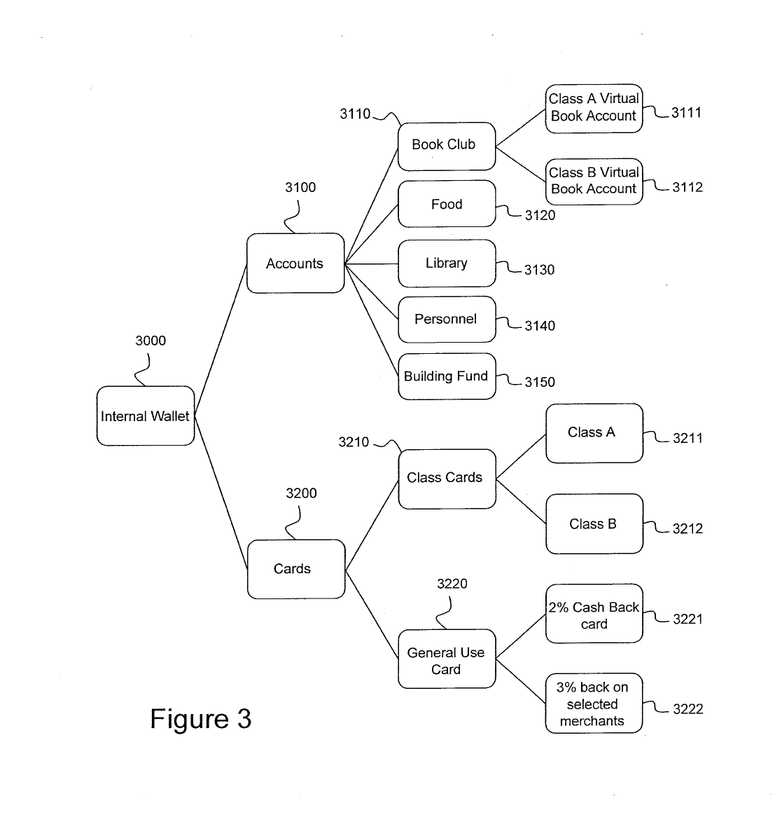

FIG. 3 is a diagram illustrating an example collection of accounts, sub-accounts, and cards in accordance with certain embodiments. An electronic wallet may contain information regarding various accounts (e.g., bank accounts) and cards (e.g., credit or debit cards), which may be structured in a tree-like hierarchy as shown in FIG. 3. FIG. 3 depicts an example internal wallet configuration for an organization such as a school or college, and other internal wallet configurations may be applicable for other types of organizations or for individuals. The term “internal wallet” refers to the fact that this wallet contains information regarding the organization's (in this case, the school's) own accounts and/or cards. In contrast, an external wallet may contain content regarding various parties (e.g., vendors who provide goods or services to the school) to whom payments are to be made or from whom payments are received, for example.

Referring to FIG. 3, in the example of an organization such a school or college, the internal wallet 3000 includes information pertinent to accounts 3100 (e.g., bank accounts for respective units within the organization) and cards 3200 (e.g., credit or debit cards). Within accounts 3100 there are the following example account categories: book club account category 3110; food account category 3120; library account category 3130; personnel account category 3140; building fund account category 3150. Each account category is associated with one or more accounts. For example, categories 3120, 3130, 3140 and 3150 may be associated with one account each, and category 3110 may be associated with a Class A virtual book account 3111 and a Class B virtual book account 3112 corresponding to respective classes A and B within the school. Cards 3200 may be class-specific (e.g., class A account 3211 and class B account 3212 are in the class cards category 3210) or may be for general use (e.g., a card 3221 that provides 2% cash back for purchases, and a card that provides 3% cash back for purchases from selected merchants, are in the general use category 3220).

Thus, the arrangement within wallet 3000 is a tree-like arrangement, with leaf nodes corresponding to respective accounts. In addition to accounts 3100 and the subtree descending therefrom, the leaf nodes within the cards 3200 subtree may also be considered “accounts” in the sense of account allocation. Thus, allocation of funds to “accounts”, as described herein, may refer to allocation of funds to cards or accounts. For example, cards 3211, 3212, 3221, and 3222 may be themselves associated with respective accounts. Whereas traditionally a user (e.g., comptroller, treasurer, or person with a similar position within an organization) has had to manually direct incoming funds to various accounts (e.g., add $1000 to the food account 3120 so that food vendors can be appropriately paid, or pay $5000 of the balance on class B credit card 3212), various embodiments of the present disclosure enable received funds (incoming to wallet 3000) to be automatically allocated to one or more accounts based on a set of allocation rules.

Example Allocation Rules

Various example allocation rules are now described with respect to the example account categories shown in FIG. 3. Although the following examples of allocation rules are in the context of an organization that is a school, such examples are non-limiting, and various other types of allocation rules may be used. Each example allocation rule determines one or more account categories based on funds data that specifies at least the amount of funds and the identity of the payor. In other words, the allocation rules map funds data to one or more account categories. In some cases, the funds data may specify additional information.

Example Allocation Rule 1: Allocate incoming funds to the category “Book Club” 3110 if: (1) the payment was made by a payor who is among a predetermined list of individuals, e.g., parents or legal guardians of students affiliated with (e.g., enrolled at or otherwise involved with) the school; and (2) the payment originated from the payor's interaction with a predetermined service provider (e.g., the payor accessed a predetermined book vendor's web site to initiate the e-commerce transaction). In this case, the URL of the service provider may be included in the funds data. For example, if a parent of a student visits a bookstore's website and initiates at that website a purchase of certain books associated with the school's curriculum, the funds from the parent can be automatically allocated to category 3110 on the basis of this allocation rule, or at least category 3110 can be automatically identified as a candidate category for allocation, subject to user confirmation.

Example Allocation Rule 2: Allocate incoming funds to the category “Food” 3120 if the payment has a payor that is a predetermined food merchant.

Example Allocation Rule 3: Allocate 20% (or any other percentage) of incoming funds to the category “Library” 3130 if the payment has a predetermined payor. For example, suppose the school receives funding from a town or municipality. A predetermined percentage (such as 20%) of the incoming funds can be automatically allocated (or identified for possible allocation) to a library account associated with category 3130.

Example Allocation Rule 4: Allocate 80% (or any other percentage) of incoming funds to the category “Personnel” 3140 if the payment has a predetermined payor. Following the preceding example, 80% of the incoming funds (received from the town or municipality) can be automatically allocated (or identified for possible allocation) to a personnel account associated with category 3140. In example allocation rules 3 and 4, the predetermined allocation proportions (ratios) may be specified by the funds data or may be stored separately from the funds data, e.g., in an external database.

Example Allocation Rule 5: Allocate the incoming funds to the category “Building Fund” 3150 if the payor specified that the purpose for the funds is the building fund account that is associated with category 3150. For example, a parent may visit a website and initiate a payment in a fixed amount, and she may use a graphical user interface to indicate that she desires that the funds be used for the school's building fund account. This indication may be represented in data (e.g., as a variable) that is part of the funds data, e.g., an input parameter to the allocation rule.

Example Allocation Rule 6: Allocate the incoming funds to Class A card 3211 if the payment has a payor who is a parent or guardian of a student affiliated with the school in class A.

Example Allocation Rule 7: Allocate the incoming funds to Class B card 3211 if the payment has a payor who is a parent or guardian of a student affiliated with the school in class B. The determination regarding the payor may be made automatically for this allocation rule as well as example allocation rule 6, e.g., by matching the payor's identity (provided in the funds data) to a list of parents/guardians for the particular class, wherein the list is maintained at a database.

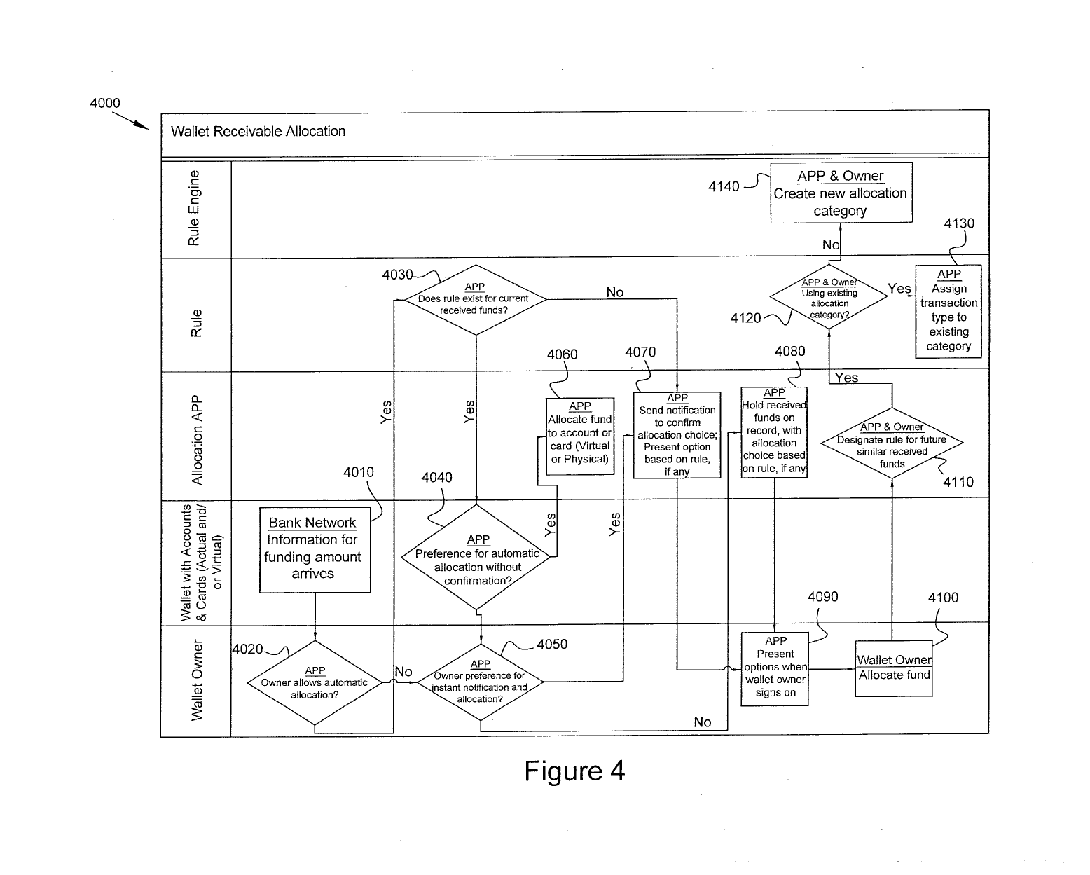

FIG. 4 is a flow diagram illustrating a process 4000 for rule-based funds allocation in accordance with certain embodiments. In one embodiment, processing related to allocation rules is performed at a user device 1105, and the allocation rules may also be stored at the user device 1105. In another embodiment, processing related to allocation rules is performed at server 1200, and only the results of the processing are sent to the user device 1105, such that the user device 1105 acts like a thin client. The processor that executes various steps may be in a user device 1100 associated with the payee or in a computer such as server 1200 that is connected to user device 1100. Regardless of where the processor that executes these steps is located, input may be solicited from the user to enable the user to flexibly participate in the funds allocation process as much or as little as she desires. For a private electronic wallet, the user is the same as the wallet owner. For a commercial or organizational electronic wallet, the user may operate and administer the wallet on behalf of a company or organization.

Referring to FIG. 4, funds data specifying the amount of incoming (received) funds is received (e.g., from a bank network) at block 4010. The funds data may also specify the payor associated with the transaction. The funds data may contain additional fields to enable automatic allocation. For example, consider a payment to a school. The payment may be associated with a student ID from a parent or guardian, who has one or more children enrolled in the school. In this example, the funds data may contain a field specifying a class fund (an account for a class containing the child or children). At 4020, if the wallet owner allows (e.g., has enabled) automatic allocation of funds, the flow proceeds to 4030; otherwise, the flow proceeds to 4050. At 4030, a computer processor is used to determine, based on the funds data, whether any allocation rule among the plurality of allocation rules is applicable for allocation of the received funds. If any allocation rule(s) is applicable, flow proceeds to 4040; otherwise, flow proceeds to block 4070.

At 4040, if a preference has been indicated for automatic funds allocation without confirmation by the wallet owner/user, at least a portion of the funds is automatically allocated (block 4060) to an account or card (virtual or physical) associated with one or more account category/categories identified by evaluation of the allocation rule. The allocation of the funds may occur by updating the appropriate account electronically. Otherwise, flow proceeds to 4050. At 4050, if a preference has been indicated for instant notification and allocation, flow proceeds to block 4070; otherwise, flow proceeds to block 4080.

At block 4070, a notification is sent to the user to select (if flow proceeded from 4030 to 4070) or confirm (if flow proceeded from 4050 to 4070) the allocation choice. If multiple possible allocation categories are identified as a result of evaluation of the allocation rules, the various options may be presented (displayed) to the user.

At block 4080, received funds are held in record (not allocated yet) along with allocation choice(s) based on the allocation rule(s), if any allocation rule(s) are applicable. For example, one or more account category/categories identified by evaluation of the allocation rule(s) may be stored in a computer database, e.g., records database 1500 or another database.

At block 4090, allocation options are presented to the user when the user signs in (e.g., using a username/password pair). The record of the applicable account category/categories may be retrieved from the database for this purpose. The user may sign in at a web portal (e.g., by visiting a predetermined website) or using an application executing on user device 1100a.

At block 4100, the wallet owner/user may manually select the allocation of funds to a particular account category or account associated with an account category. User device 1100 or server 1200 may receive an allocation confirmation message containing the wallet owner's selection electronically from the wallet owner. Allocation of funds may then occur in response to the receipt of the allocation confirmation message.

In some embodiments, after allocation of received funds has occurred; post-processing is performed. At block 4110, if the wallet owner/user requested designation of a rule for allocating future received funds having associated payment characteristics similar to the present received funds, flow proceeds to 4120. At 4120, if the wallet owner requests that an existing allocation category be the target for future similar allocations, then the present transaction type is assigned to one of the existing allocation categories (block 4130); otherwise, flow proceeds to block 4140, at which a new allocation category is created. At block 4130, consider an example where an allocation category (e.g., class A fund) exists, but a new student or payment is submitting a payment. Thus, a rule does not exist presently for this type of transaction. By providing the capability to dynamically modify the set of rules, certain embodiments of the present disclosure enable wallet owners/users to flexibly adapt to various scenarios.

Thus, with some embodiments of the present disclosure, administrative (e.g., book-keeping) tasks related to allocation of funds are simplified for the wallet owner. The wallet owner can customize the level of her interaction in the allocation process, so that funds can be allocated automatically or she can select one or more allocation options that are automatically identified.

In various embodiments, the allocation rules may be stored at user device 1100, at server 1200, or at wallet database 1400 (e.g., along with the remainder of the payee's wallet contents, which may be synchronized periodically with user device 1100). In embodiments in which the allocation rules are stored at server 1200 or wallet database 1400, the transaction solution provider has the capability to determine allocation choices, push notification allocation choices/options to the payee (e.g., via e-mail, text messaging, or another messaging technique), respond to the payee's instructions, and allocate funds, even if the payee's device 1100 is not on at certain moments in time.

In certain embodiments, if the result of check 4030 is that none of the allocation rules is determined to be applicable for allocation of the received funds, another check is performed to determine whether any account of the payee was previously specified as a default allocation account. If such a default allocation account exists, the received funds may be allocated (automatically, or upon user confirmation) to the default allocation account. If no such default allocation account exists, an electronic notification may be sent to the user, and an allocation message that specifies at least one account of the payee may then be received electronically from the user (like at block 4100), so that funds allocation can occur in response to the received allocation message.

In certain embodiments, a user/wallet owner can use a public computer to provide (send) instructions (e.g., to server 1200) regarding funds allocation and to create new rules. In this case, the allocation rules may be stored “in the cloud” (e.g., at wallet database 1400, records database 1500, or another database connected to network 1300), and the allocation rules can be synchronized to the user's device 1100 during a synchronization event.

FIG. 5 is a flow diagram illustrating another process for rule-based funds allocation in accordance with certain embodiments. After process 5000 begins, funds data is received (block 5100). The funds data specifies at least an amount of received funds and a payor associated with a transaction. At block 5200, a computer processor is used to determine, based on the funds data, whether any allocation rule among a plurality of allocation rules is applicable for allocation of the received funds. If an allocation rule is applicable for allocation of the received funds, then the allocation rule is evaluated with the funds data to identify at least one account category (block 5300), wherein each account category is associated with at least one account of a payee associated with the transaction. At block 5400, at least a portion of the received funds is allocated to at least one of the accounts associated with the identified account category or categories.

FIG. 6 is a flow diagram illustrating another process for rule-based funds allocation in accordance with certain embodiments. After process 6000 begins, funds data is received (block 6100). The funds data specifies at least an amount of received funds and a payor associated with a transaction. A payee associated with the transaction is an educational institution. At block 6200, at least one computer processor is used to determine that the payor is a parent or guardian of a student affiliated with the educational institution. If the payor is the parent or guardian of the student, then the computer processor(s) is/are used to determine whether any allocation rule among a plurality of allocation rules is applicable for allocation of the received funds (block 6300). If an allocation rule is applicable for allocation of the received funds, the allocation rule is evaluated with the funds data to identify at least one account category (block 6400), wherein each account category is associated with at least one account of the payee. At block 6500, at least a portion of the received funds is allocated to at least one of the accounts associated with the identified account category or categories.

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other components and processes described herein. Each component and process also can be used in combination with other assembly packages and processes.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A computer-implemented method of allocating funds, the method comprising:
receiving funds data that specifies at least an amount of received funds and a payor;
determining, using a computer processor, based on the funds data, whether any allocation rule among a plurality of allocation rules is applicable for allocation of the received funds;
responsive to a determination that an allocation rule is applicable for allocation of the received funds, evaluating the allocation rule with the funds data to identify at least one account category, wherein each account category is associated with at least one account of a payee, and allocating at least a portion of the received funds to at least one of the accounts associated with the at least one account category.

2. The method of claim 1, wherein the processor is in a device associated with the payee.

3. The method of claim 2, wherein the processor is in a computer connected via a network to a device associated with the payee.

4. The method of claim 1, wherein the at least a portion of the received funds is allocated automatically, without receiving a confirmation from a user associated with the payee before the allocating.

5. The method of claim 1, wherein the allocating at least a portion of the received funds includes:
upon identification of the at least one account category, automatically sending an electronic notification to a user associated with the payee, wherein the notification displays the at least one account associated with an account category identified by evaluation of the allocation rule; and
receiving an allocation confirmation message electronically from the user;
wherein the at least a portion of the received funds is allocated responsive to the received allocation confirmation message.

6. The method of claim 1, wherein the allocating at least a portion of the received funds includes:
storing, in a computer database, a record of the at least one account category identified by evaluation of the allocation rule;
upon sign-on of a user associated with the payee, retrieving from the database the record of the at least one account category, and displaying the at least one account category to the user; and
receiving an allocation confirmation message electronically from the user;
wherein the at least a portion of the received funds is allocated responsive to the received allocation confirmation message.

7. The method of claim 1, further comprising:
responsive to a determination that none of the plurality of allocation rules is applicable for allocation of the received funds, determining whether any account of the payee was previously specified as a default allocation account.

8. The method of claim 7, further comprising:
responsive to a determination that a default allocation account exists, allocating the received funds to the default allocation account.

9. The method of claim 7, further comprising:
responsive to a determination that no default account exists, sending an electronic notification to a user associated with the payee;
receiving an allocation message electronically from the user, wherein the allocation message specifies at least one account of the payee; and
wherein the allocating is performed responsive to the received allocation message.

10. The method of claim 1, further comprising:
receiving an indication from a user associated with the payee to create a new allocation rule for future receivable funds sharing at least one characteristic with the received funds data; and
creating a new allocation rule responsive to the received indication.

11. The method of claim 10, wherein the new allocation rule maps to an existing account category.

12. The method of claim 10, further comprising creating a new account category, wherein the new allocation rule maps to the new account category.

13. The method of claim 1, wherein the allocation rule maps the funds data specifying a predetermined payor to at least two account categories, and portions of the received funds are allocated to respective accounts associated with said at least two account categories, according to a predetermined allocation ratio applied to the amount of received funds.

14. The method of claim 1, wherein the payee is an educational institution, and the allocation rule maps to the at least one account category based on a determination that the payor is a parent or guardian of a student affiliated with the educational institution.

15. The method of claim 14, wherein the funds data further specifies a service provider for the educational institution, and the allocation rule maps to one of the account categories based on a determination that the funds data specifies the service provider.

16. The method of claim 14, further comprising determining a class for the student, wherein the at least a portion of the received funds is allocated to an account associated with the class.

17. The method of claim 1, wherein the payee is an educational institution, the payor is a service provider for the educational institution, and the allocation rule maps the funds data specifying the service provider to the at least one account category.

18. A non-transitory computer readable storage medium comprising instructions stored thereon, the instructions when executed causing a computer processor to perform the operations of:
receiving funds data that specifies at least an amount of received funds and a payor;
determining, based on the funds data, whether any allocation rule among a plurality of allocation rules is applicable for allocation of the received funds;
responsive to a determination that an allocation rule is applicable for allocation of the received funds, evaluating the allocation rule with the funds data to identify at least one account category, wherein each account category is associated with at least one account of a payee, and allocating at least a portion of the received funds to at least one of the accounts associated with the at least one account category.

19. The non-transitory computer readable storage medium of claim 18, wherein the processor is in a device associated with the payee.

20. The non-transitory computer readable storage medium of claim 18, wherein the processor is in a computer connected via a network to a device associated with the payee.

21. A computer-implemented method of allocating funds, the method comprising:
receiving funds data that specifies at least an amount of received funds and a payor associated with a transaction, wherein a payee associated with the transaction is an educational institution;
determining, using at least one computer processor, that the payor is a parent or guardian of a student affiliated with the educational institution;
determining, using the at least one computer processor, based on the determination that the payor is the parent or guardian of the student, whether any allocation rule among a plurality of allocation rules is applicable for allocation of the received funds;
responsive to a determination that an allocation rule is applicable for allocation of the received funds, evaluating the allocation rule with the funds data to identify at least one account category, wherein each account category is associated with at least one account of the payee, and allocating at least a portion of the received funds to at least one of the accounts associated with the at least one account category.

22. The method of claim 21, wherein the processor is in a device associated with the payee.

23. The method of claim 21, wherein the processor is in a computer connected via a network to a device associated with the payee.

24. The method of claim 21, wherein the at least a portion of the received funds is allocated automatically, without receiving a confirmation from a user associated with the payee before the allocating.

25. The method of claim 21, wherein the allocating at least a portion of the received funds includes:
upon identification of the at least one account category, automatically sending an electronic notification to a user associated with the payee, wherein the notification displays the at least one account associated with an account category identified by evaluation of the allocation rule; and
receiving an allocation confirmation message electronically from the user;
wherein the at least a portion of the received funds is allocated responsive to the received allocation confirmation message.

26. The method of claim 21, wherein the allocating at least a portion of the received funds includes:
storing, in a computer database, a record of the at least one account category identified by evaluation of the allocation rule;
upon sign-on of a user associated with the payee, retrieving from the database the record of the at least one account category, and displaying the at least one account category to the user; and
receiving an allocation confirmation message electronically from the user;
wherein the at least a portion of the received funds is allocated responsive to the received allocation confirmation message.
